(19) United States
(12) Patent Application Publication
(10) Pub. No.: US 2026/0328026 A1
(43) Pub. Date: Oct. 22, 2026

(54) ANTI-PINCH PROTECTION SYSTEM UTILIZING LATCH CONTROL

(71) Applicant: MAGNA CLOSURES INC., Newmarket (CA)

(72) Inventors: Joseph OSMIALOWSKI, Newmarket (CA); John G. ZEABARI, Highland, MI (US); Francesco CUMBO, Pisa (IT)

(73) Assignee: MAGNA CLOSURES INC., Newmarket (CA)

(21) Appl. No.: 19/552,856

(22) Filed: Feb. 27, 2026

Related U.S. Application Data
(63) Continuation of application No. 17/561,402, filed on Dec. 23, 2021, now abandoned.
(60) Provisional application No. 63/145,724, filed on Feb. 4, 2021.

(51) Int. Cl. E05B 81/20; E05B 77/00; E05B 79/20; E05B 81/06; E05B 81/56; E05B 81/70; E05B 83/18; E05B 83/24

(52) U.S. Cl. CPC E05B 81/21; E05B 77/00; E05B 81/06; E05B 81/56; E05B 81/70; E05B 79/20; E05B 83/18; E05B 83/243

(57) ABSTRACT

A system for detecting an obstacle between a closure panel and a body of a vehicle, comprising: an actuator for moving the closure panel from a partially closed position to a closed position; a sensor for sensing a position of the closure panel between the partially closed and the closed position; and a controller for receiving position signals from the sensor and for controlling operation of the actuator; wherein the controller is adapted to inhibit moving of the closure panel when the sensor detects an improper change in the position of the closure panel during operation of the actuator.

### CROSS-REFERENCE TO RELATED APPLICATION

This application is a Continuation of U.S. patent application Ser. No. 17/561,402 filed Dec. 23, 2021, which claims priority from the benefit of the filing date of U.S. Provisional Patent Application no. 63/145,724 filed on Feb. 4, 2021, entitled “ANTI-PINCH PROTECTION SYSTEM UTILIZING LATCH CONTROL”, the contents of which are herein incorporated by reference.

### FIELD OF THE INVENTION

This present invention relates to latch operation for vehicle closure panels.

### BACKGROUND

A typical motor vehicle door is mounted in a door frame on the vehicle and is movable between open and closed positions. Usually the door is held in a closed position by the latching engagement between a spring-biased ratchet pivotally mounted inside the door latch and a U-shaped striker secured to the door frame. The ratchet is most often spring-biased toward the unlatched position to release the striker and is maintained in the latched position to hold the striker by a spring-biased pawl or other mechanical structure. The ratchet cannot pivot to release the striker until the pawl is moved.

It is often difficult, however, to completely close and latch manually latching vehicle doors on current model vehicles because the desire to reduce vehicle weight and to improve fuel economy has led engineers to design vehicles with relatively thin and lightweight doors. Often relatively hard door seals are used with these thin, lightweight doors to improve sealing around the door, particularly at high driving speeds. Because many vehicle doors are relatively lightweight and have relatively hard door seals, many vehicles doors often have insufficient internal energy when pushed closed to compress these hard door seals and fully pivot the ratchet to the latched position to latch the door.

Power assisted door latch assemblies have been developed to overcome the problems associated with latching doors with lightweight construction and hard door seals. Power assisted door latch assemblies allow low internal energy or soft closure of lightweight doors without the need to slam the door even with the increased seal pressure that results from relatively hard door seals.

Current problems exist with powered latch assemblies, including complicated latch component configurations and large and inconvenient assembly footprints. Further, when using a power cinching latch, it can be complicated to provide anti-pinch protection for a finger or foreign object during the cinching operation. Current state of the art pinch sensors can provide some pinch protection, however these current sensor systems can be expensive and hard to package in a vehicle closure panel system. For example, pinch strips can be employed on lift gates, as long rubber strips that run along the outside edge of the lift gate where a pinch event can occur, such that when an object presses on the rubber strip the object is detected and the gate motion is either stopped or reversed. However, these pinch strips cannot always be positioned in all locations where a pinch event can occur. As well, these pinch strips may not be sensitive enough to inhibit pinch events during a cinch operation of the latch.

### SUMMARY

It is an object to the present invention to provide a pinch detection system or method to obviate or mitigate at least one of the above-mentioned problems.

Current problems exist with powered latch assemblies, including complicated latch component configurations and large and inconvenient assembly footprints. Further, when using a power cinching latch, it can be complicated to provide anti-pinch protection for a finger or foreign object during the cinching operation. Current state of the art pinch sensors can provide some pinch protection, however these current sensor systems can be expensive and hard to package in a vehicle closure panel system. For example, pinch strips can be employed on lift gates, as long rubber strips that run along the outside edge of the lift gate where a pinch event can occur, such that when an object presses on the rubber strip the object is detected and the gate motion is either stopped or reversed. However, these pinch strips cannot always be positioned in all locations where a pinch event can occur. As well, these pinch strips may not be sensitive enough to inhibit pinch events during a cinch operation of the latch. One or more aspects of the claimed invention are meant to address the current problem(s).

A first aspect provided is a system for detecting an obstacle between a closure panel and a body of a vehicle, comprising: an actuator for moving the closure panel from a partially closed position to a closed position; a sensor for sensing a position of the closure panel between the partially closed and the closed position; and a controller for receiving position signals from the sensor and for controlling operation of the actuator; wherein the controller is adapted to inhibit moving of the closure panel when the sensor detects an improper change in the position of the closure panel during operation of the actuator.

A second aspect provided is a latch for a vehicle having a closure panel, the latch comprising: a ratchet for retaining a striker between a striker releasing position corresponding to an open position of the closure panel and a secondary striker capture position corresponding to a partially closed position of the closure panel and a primary striker capture position corresponding to a fully closed position of the closure panel; an actuator for moving the ratchet from the secondary striker capture position to the primary striker capture position; a sensor for sending the position of the closure panel between the partially closed position and the fully closed position; a controller for receiving position signals from the sensor and for controlling operation of the actuator; wherein the controller is adapted to cease moving of the ratchet when the sensor detects an improper change in the position of the closure panel during operation of the actuator.

A third aspect provided is a method of moving a closure panel between a partially closed position and a fully closed position, the method comprising: controlling an actuator for moving the closure panel from the partially opened position to the fully closed position; detecting a position of the closure panel when moving the closure panel; and controlling the actuator to inhibit movement of the closure panel in response to detecting an improper change in the position of the closure panel during operation of the actuator.

A fourth aspect provided is a system for detecting an obstacle between a closure panel and a body of a vehicle, comprising: an actuator for moving the closure panel from a partially closed position to a closed position; and a sensor for sensing a position of the closure panel between the partially closed and the closed position; wherein the actuator is adapted to inhibit moving of the closure panel between the partially closed position and the closed position when the sensor detects an improper change in the position of the closure panel during operation of the actuator.

A fifth aspect provided is a system for detecting an obstacle between a closure panel and a body of a vehicle, the system comprising: an actuator for moving the closure panel from a partially closed position to a closed position; and a sensor for sensing a position of the closure panel between the partially closed and the closed position; wherein operation of the actuator is controlled to inhibit moving of the closure panel when one or more signals from the sensor represents an improper change in the position of the closure panel during operation of the actuator.

Further aspects provided are: wherein controlling the actuator comprises a variable output force during moving the closure panel from the partially closed position to the fully closed position; wherein a variable output force is equal to or greater than a force of a seal positioned between the closure panel and a vehicle body, the seal resisting movement of the closure panel from the partially closed position to the fully closed position; and wherein a variable output force is less than a maximum limit force at all positions of the closure panel between the partially closed position and the fully closed position.

A sixth aspect provided is a system for moving a closure panel relative to a body of a vehicle, the system including an actuator having a motor for moving the closure panel from a first position to a second position against an obstacle, and a motor controller for controlling a current to the motor to generate a motor output force, where the motor controller is adapted to control the current such that the motor output force increases as the closure panel is moved from the first position to the second position without causing the closure panel to apply a force on the obstacle exceeding a predetermined force. Further aspects provided are the motor output force is correlated to a position of the closure panel between the first position and the second position.

A seventh aspect is a system for moving a closure panel relative to a body of a vehicle, the system including an actuator having a motor for moving the closure panel from a first position to a second position against an obstacle, and a motor controller for controlling a current to the motor to generate a motor output force, the motor controller being adapted to control the current such that the motor output force compensates for a system resistance against the closure panel moving from the first position to the second position without causing the closure panel to apply a force on an obstacle positioned between the body and the closure panel exceeding a predetermined force.

An eighth aspect provided is a latch for a motor vehicle having a closure panel, the latch having a ratchet for retaining a striker between a striker releasing position corresponding to an open position of the closure panel and striker capture position corresponding to a closed position of the closure panel, a pawl for hold the ratchet in the striker capture position, and a sensor associated with the ratchet for detecting an position of the ratchet between the striker releasing position and the striker capture position. Further aspects of the latch are the sensor is configured to detect an absolute position of the ratchet. Further aspects of the latch are a geartrain is provided between the ratchet and the sensor. Further aspects of the latch are a controller is provided electrically connected to the sensor and to a motor for controlling the motion of the ratchet. Further aspects of the latch are the controller is configured to control the actuator for moving the ratchet based on the position signal received from the sensor. Further aspects of the latch are the controller is configured to control the actuator to move the ratchet from a cinch start position to a cinched position based on the position signal received from the sensor. Further aspects of the latch are the controller is configured to control the actuator such that a force applied to the striker by the ratchet is according to a force profile correlated to the position of the closure panel.

### BRIEF DESCRIPTION OF THE DRAWINGS

The foregoing and other aspects will be more readily appreciated having reference to the drawings, wherein:

FIG. 1a is a perspective view of an example vehicle;

FIG. 1b is a perspective view of a further example of a vehicle;

FIG. 1c is a perspective view of a further example of a vehicle;

FIG. 2 shows an example powered cinch latch mechanism in an unlatched configuration for the vehicle of FIG. 1a;

FIG. 3a, b, c shows details of operation of the mechanism of FIG. 2 for a pinch event;

FIG. 4 shows the powered cinch latch mechanism of FIG. 2 in a primary latch position;

FIG. 5 shows an alternative view of the powered cinch latch mechanism of FIG. 2 in a primary latch position;

FIG. 6 shows an alternative embodiment of the powered cinch latch mechanism of FIG. 2;

FIG. 7 shows an alternative embodiment of the cinched latch mechanism of FIG. 2 having a plurality of electronic motors;

FIG. 8 shows an example embodiment of the pinch detection system of the vehicle of FIG. 1a for the example latch configuration of FIG. 2;

FIG. 9 shows a further example embodiment of the pinch detection system of the vehicle of FIG. 1a;

FIG. 10 shows a still further example embodiment of the pinch detection system of the vehicle of FIG. 1a;

FIG. 11 shows a still further example embodiment of the pinch detection system of the vehicle of FIG. 1a;

FIG. 12 shows a still further example embodiment of the pinch detection system of the vehicle of FIG. 1a;

FIG. 13 shows a still further example embodiment of the pinch detection system of the vehicle of FIG. 1a;

FIG. 14 shows an example flowchart of operation for the pinch detection system of FIG. 8;

FIG. 15 shows a further example flowchart of operation for the pinch detection system of FIG. 8;

FIG. 16a, b show example flowcharts of calibration operations for the pinch detection system of FIG. 8;

FIG. 17 is an example table for calibration data of the pinch detection system of FIG. 8;

FIGS. 18, 19, 20, 21, 22, 23 show example graphs for operation of the pinch detection system of FIG. 8;

FIGS. 24, 25 show flowcharts for still further alternative operations of the pinch detection system of FIG. 8; and

FIG. 26a, b, c, d 27 show an alternative embodiment of the sensor of the pinch detection system of FIG. 8.

### DESCRIPTION

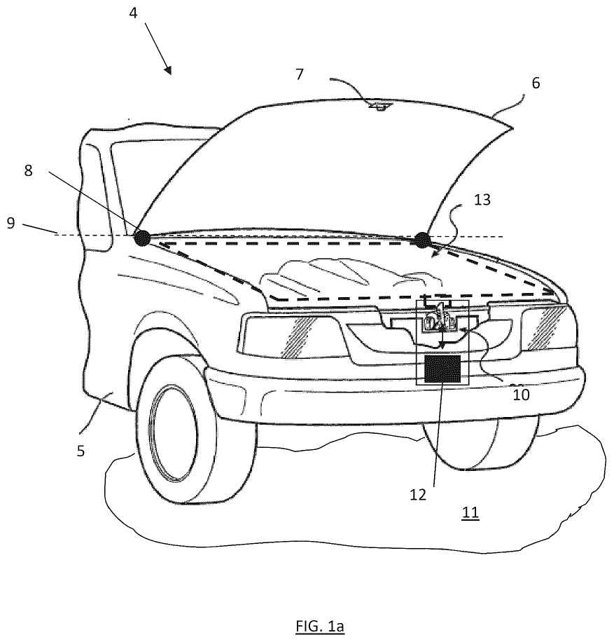

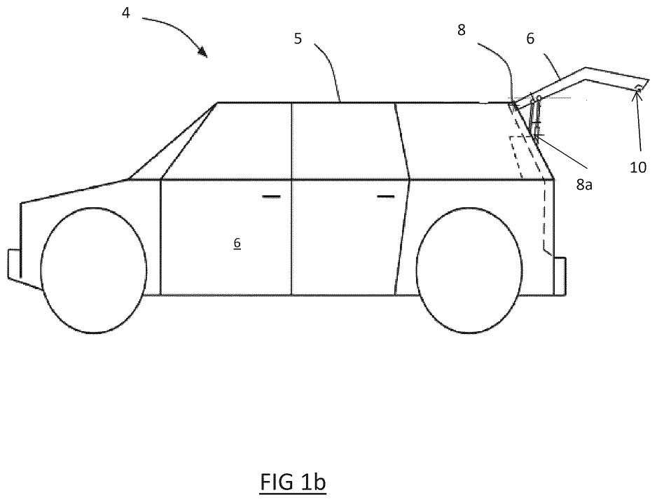

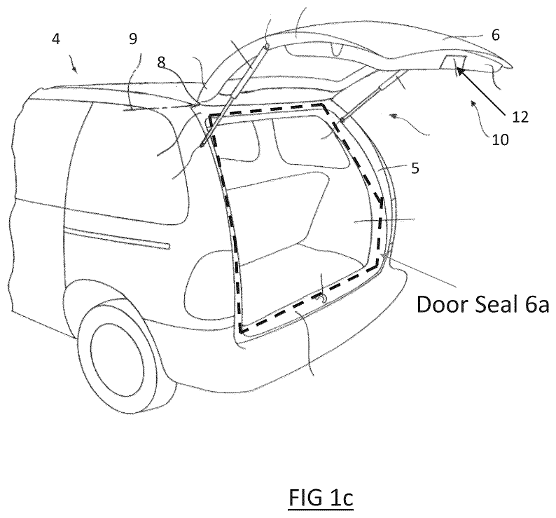

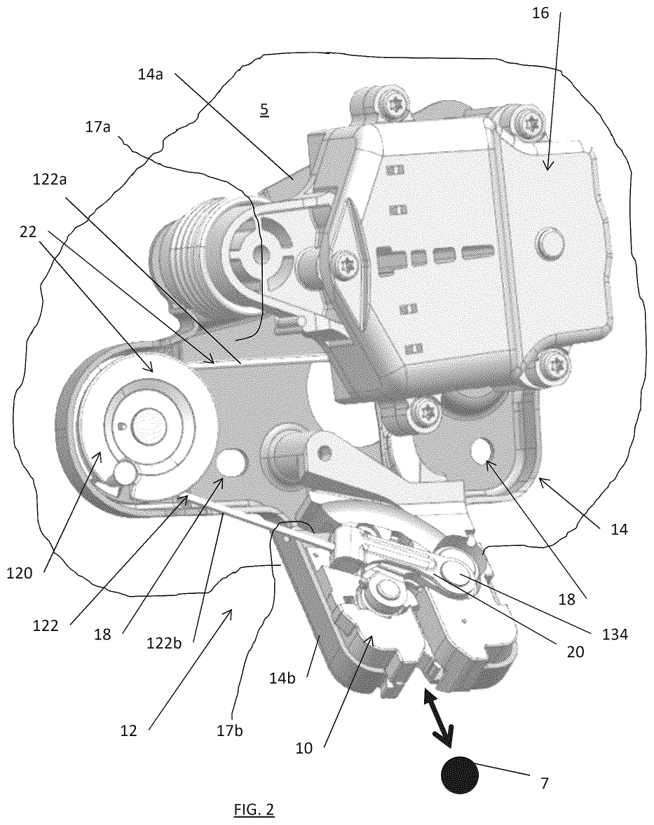

Referring to FIG. 1a, shown is a vehicle 4 with a vehicle body 5 having one or more closure panels 6 coupled to the vehicle body 5. The closure panel 6 is connected to the vehicle body 5 via one or more hinges 8 and a latch (assembly) 10 (e.g. for retaining the closure panel 6 in a closed position once closed). It is also recognized that the hinge 8 can be configured as a biased hinge 8 to bias the closure panel 6 towards an open position and/or towards the closed position. As such, the hinge 8 can also incorporate one or more actuated struts to assist in opening and closing of the closure panel 6, as desired. The closure panel 6 has a mating latch component 7 (e.g. striker) mounted thereon for coupling with the latch 10 mounted on the vehicle body 5. Alternatively, latch 10 can be mounted on the closure panel 6 and the mating latch component (striker) 7 mounted on the body 5 (not shown). For example, the latch 10 can have a ratchet 24 (see FIG. 2) for retaining a striker 7 between a striker releasing position corresponding to an open position of the closure panel 6 and a secondary striker capture position corresponding to a partially closed position (e.g. secondary position) of the closure panel 6. Further, the ratchet 24 can be configured for having a primary striker capture position corresponding to a fully closed position of the closure panel 6 (e.g. a latched or primary position).

Referring to FIG. 1b, shown is the vehicle 4 with the vehicle body 5 having an alternative embodiment of the one or more closure panels 6 coupled to the vehicle body 5, including one or more struts 8a (e.g. power actuated struts assembly 8a). The closure panel 6 is connected to the vehicle body 5 via one or more hinges 8 and latch 10 (e.g. for retaining the closure panel 6 in a closed position once closed). It is recognized that examples of the closure panel 6 can include a hood panel, a door panel, a hatch panel and other panels as desired.

The hinges 8 (and/or the struts 8a) can provide for movement of the closure panel 6 between a closed panel position (shown in dashed outline) and an open panel position (shown in solid outline), such that the hinges 8 can be involved during the movement of the closure panel 6 between the open panel position and the closed panel position, can be involved in driving the movement of the closure panel 6 towards the open panel position (e.g. as a biased hinge 8 or strut 8a), or can be involved in driving the movement of the closure panel 6 towards the closed panel position. In the embodiment shown, the closure panel 6 pivots between the open panel position and the closed panel position about a pivot axis 9 (e.g. of the hinge 8), which can be configured as horizontal or otherwise parallel to a support surface 11 of the vehicle 4. In other embodiments, the pivot axis 9 may have some other orientation such as vertical or otherwise extending at an angle outwards from the support surface 11 of the vehicle 4. In still other embodiments, the closure panel 6 may move in a manner other than pivoting, for example, the closure panel 6 may translate along a predefined track or may undergo a combination of translation and rotation between the open and closed panel positions, such that the hinge 8 includes both pivot and translational components (not shown). As can be appreciated, the closure panel 6 can be embodied, for example, as a hood, passenger door, or lift gate (otherwise referred to as a hatch) of the vehicle 4.

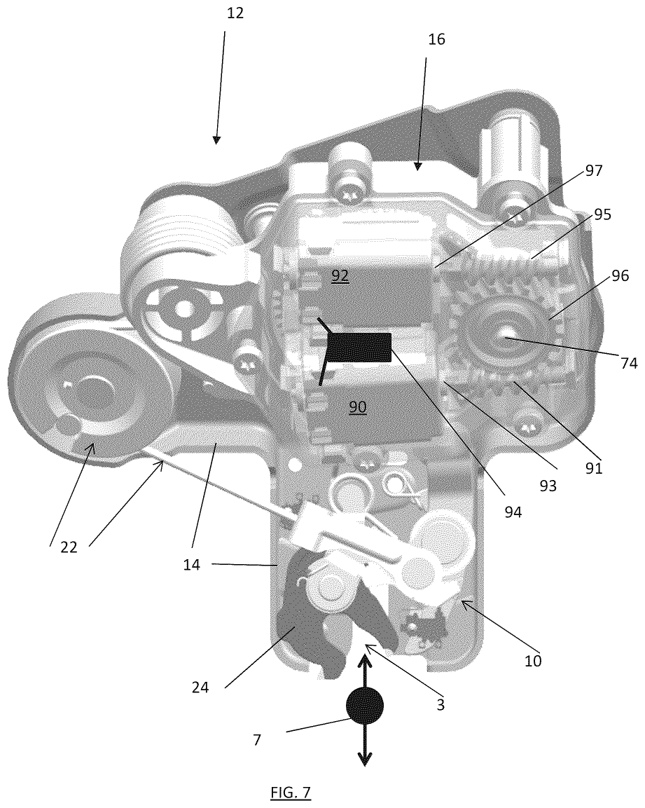

Also provided is a power latch system 12 (also referred to as latch system 12-see FIG. 2) coupled to the latch 10, as further described below. The power latch system 12 is configured for actuating the operation of the latch 10. In this manner, the power latch system 12 can be used to forcefully provide, during deployment, some form of force assisted open operation (e.g. full open, partial open, etc.) of the closure panel 6 and/or some form of force assisted close operation (e.g. full open, partial open, etc.) of the closure panel 6, for example as provided as a cinching operation in order to move the closure panel 6 to a fully closed position against close resistance induced by presence of door seals 6a, see FIG. 1c. As such, it is recognized that the compressible seals 6a (e.g. rubber) have an effect on the force the cinch actuator 90, 92 (e.g. a component of the power latch system 12—see FIG. 7) needs to overcome during cinching.

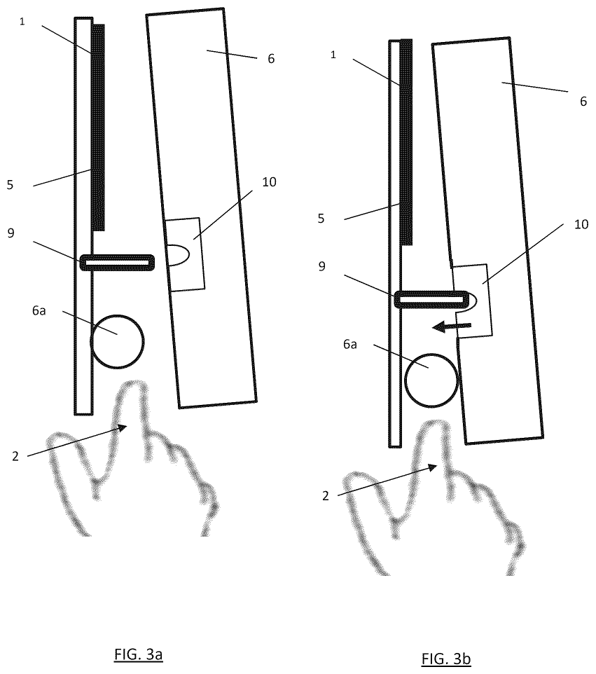

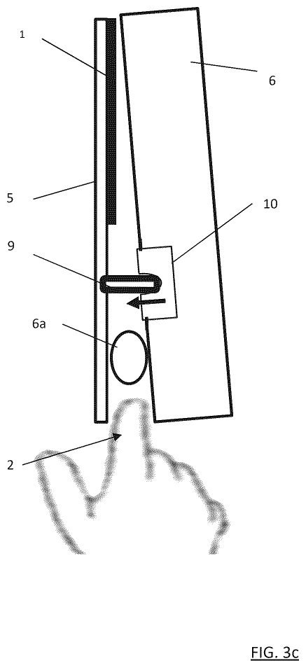

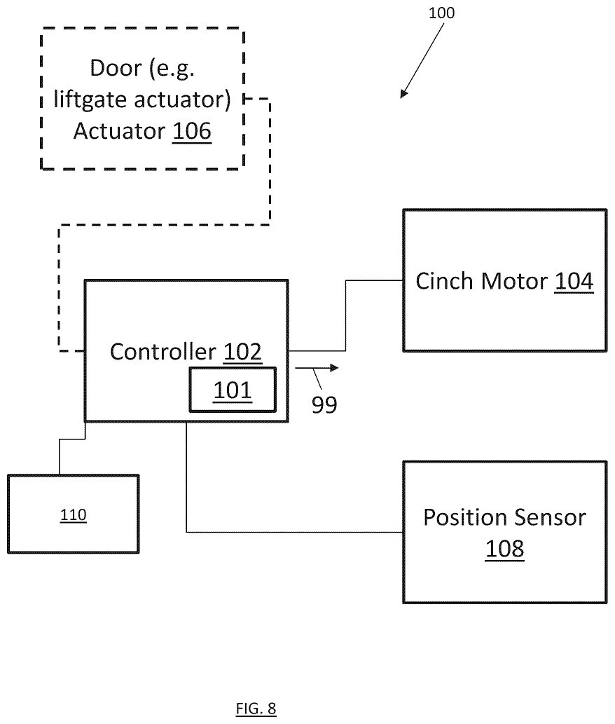

Referring to FIGS. 3a, 3b, 3c, shown is an example closure panel 6 moving in an open position (FIG. 3a where the striker 7 is not engaged with the latch 10), a partially closed position (FIG. 3b where the striker is engaged with the latch position) where the cinch function of the power latch system 12 has begun to activate, and a cinching operation (FIG. 3c where the closure panel 6 is closing using the cinch function of the actuator(s) 90, 92) such that closure panel 6 is moving using cinch actuation towards the cinched or primary closed position. It is recognized that during cinch the seal 6a would become incrementally compressed from the start to the end of the cinch operation. In particular, FIG. 3c shows how a pinch of a foreign object 2 (e.g. obstacle) can still occur between the door edge and the vehicle body during a cinch function. In particular, FIGS. 3a, 3b, 3c show how a pinch strip sensor 1 may not assist in detection of the foreign object 2 positioned nearer to the latch 10. Advantageously, the below described operation of the power latch 12 in conjunction with a pinch detection system 100 (see FIG. 8). As further discussed below, operation of the pinch detection is operating during the cinch operation of the latch 10 (as assisted by the power latch system 12), recognizing that the reason for cinch operation is to overcome seal 6a load. It is recognized that in current window pinch detection systems, these systems don't care to detect a pinch at the point of a window seal becoming compressed, as by then the gap between the window glass and the window seals are already closed (thereby negating the possibility of a foreign object being positioned between the window glass and the window seal). As such, window regulator motors are only just powered to overcome the force of their seal exerted on the window glass without considering any pinch event at in that stage.

For vehicles 4 in general, the closure panel 6 can be referred to as a partition or door, typically hinged, but sometimes attached by other mechanisms such as tracks, in front of an opening 13 which can be used for entering and exiting the vehicle 4 interior by people and/or cargo. It is also recognized that the closure panel 6 can be used as an access panel for vehicle 4 systems such as engine compartments and also for traditional trunk compartments of automotive type vehicles 4. The closure panel 6 can be opened to provide access to opening, or closed to secure or otherwise restrict access to the opening 13. It is also recognized that there can be one or more intermediate open positions (e.g. unlatched position) of the closure panel 6 between a fully open panel position (e.g. unlatched position) and fully closed panel position (e.g. latched position), as provided at least in part by the hinges 8 and latch 10, as assisted by the power latch system 12. For example, the power latch system 12 can be used to provide an opening force (or torque) and/or a closing force (or torque) for the closure panel 6.

Movement of the closure panel 6 (e.g. between the open and closed panel positions) can be electronically and/or manually operated, where power assisted closure panels 6 can be found on minivans, high-end cars, or sport utility vehicles (SUVs) and the like. As such, it is recognized that movement of the closure panel 6 can be manual or power assisted during operation of the closure panel 6 at, for example: between fully closed (e.g. locked or latched) and fully open (e.g. unlocked or unlatched); between locked/latched and partially open (e.g. unlocked or unlatched); and/or between partially open (e.g. unlocked or unlatched) and fully open (e.g. unlocked or unlatched). It is recognized that the partially open configuration of the closure panel 6 can also include a secondary lock (e.g. closure panel 6 has a primary lock configuration at fully closed and a secondary lock configuration at partially open-for example for latches 10 associated with vehicle hoods).

In terms of vehicles 4, the closure panel 6 may be a hood, a lift gate, or it may be some other kind of closure panel 6, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13 in the body 5 of the vehicle 4. Also contemplated are sliding door embodiments of the closure panel 6 and canopy door embodiments of the closure panel 6, such that sliding doors can be a type of door that open by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 4 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 5 of the vehicle at the front, side or back of the door, as the application permits. It is recognized that the body 5 can be represented as a body panel of the vehicle 4, a frame of the vehicle 4, and/or a combination frame and body panel assembly, as desired.

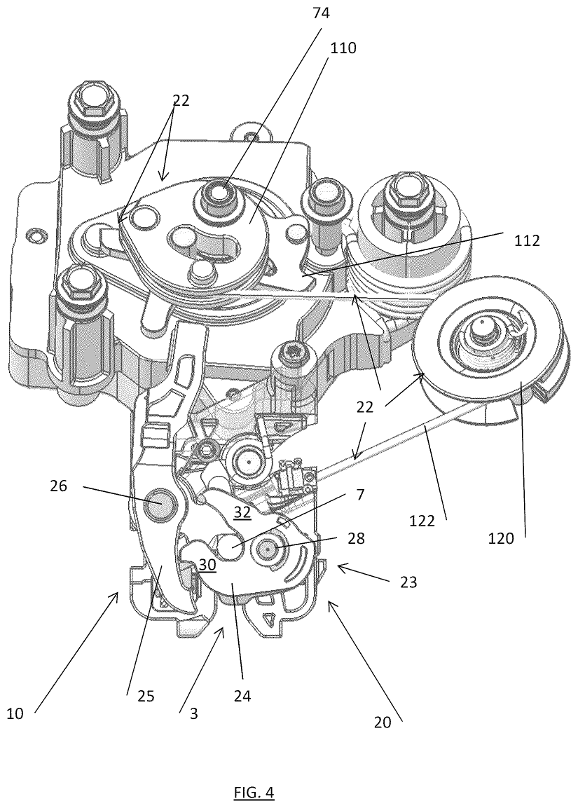

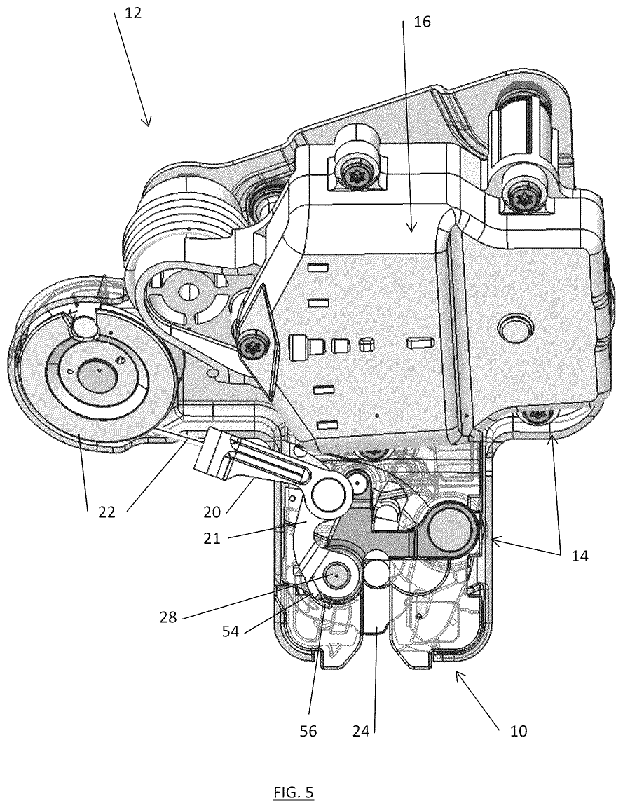

Referring to FIG. 4, shown is an example power latch assembly 12 having a frame 14, a rotary actuator system 16 (containing one or more motors / actuators 90, 92—see FIG. 7) mounted on the frame 14 and the latch 10 mounted on the frame 14. The power latch assembly 12 can be coupled to the body 5. The latch 10 is oriented on the frame 14 so as to be aligned to engage the mating latch component 7 (e.g. striker 7). The rotary actuator system 16 is coupled to a cinch member 20 (e.g. cinch arm 20) via a cinch linkage 22 (e.g. pulley and cable system as further described below) and also to one or more latch components 23 (e.g. ratchet 24 and/or pawl 25 as further described below-see FIG. 3). As such, the cinch member 20 can be actuated (e.g. pulled) by the cinch linkage 22 to operate the closure panel 6 from a partially closed position to a fully closed position, during the cinch operation, as the cinch member 20 can be coupled to the ratchet 24 via a cinch lever 21 arm. It is also recognized that the cinch linkage 22, can be provided as a rigid linkage rather than as a flexible linkage involving cables. For example, the cinch linkage 22 can be embodied as a sector gear (or other series of rigid members) connected to the cinch member 20 and/or the cinch lever 21 at one end of the cinch linkage 22 (see FIG. 5). At the other end of the cinch linkage 22, a gear 22a can be connected to an output shaft 74 that thus drives the gear 22a to move the member 20 in order to cinch the latch 10 as described.

It is recognized that the cinch member 20 (as operated by actuation of the cinch actuator/motor 90, 92) can act directly or indirectly on the ratchet 24 and/or the striker 7 in order to move the ratchet 24 from the partially closed position to the fully closed position (e.g. latched such that the pawl 25 retains the ratchet 24 in the latched position and as such the seal 6a is compressed between the closure panel 6 and the body 5). In other words, the cinch member 20 is actuated by the cinch actuator/motor 90, 92 (see FIG. 7) in order to cause the ratchet to move from the partially closed to the closed position (e.g. latched).

Referring to FIGS. 4, 5, 6, the latch 10 includes a number of latch elements 23 (e.g. ratchet 24, cinch linkage 22, cinch member 20, cinch lever 21 and pawl 25) that are configured to cooperate with the mating latch component 7 in order to retain the mating latch component 7 within a slot 3 when the closure panel 6 (see FIG. 1a, b, c) is in the closed position (e.g. locked), or otherwise to drive the mating latch component 7 out of the slot 3 when the closure panel 6 is in the open position. The fish mouth or slot 3 is sized for receiving the mating latch component 7 therein, in other words the slot 3 of the latch 10 is configured for receiving a keeper (e.g. striker) of the mating latch component 7. The slot 3 has an open top end and a closed bottom end as shown. The latch elements 23 of the ratchet 24 and pawl 25 are pivotally secured to the frame plate 14 via respective shafts 28, 26. The ratchet 24 includes an arm 30 and an arm 32 spaced apart to define a generally u-shaped slot 103 there between (e.g. a hook of arm 30 and a lip of arm 32 that extends laterally beyond the hook). Note that in FIG. 4 the latch 10 with associated ratchet 24 are shown in the fully or primary closed position (e.g. facilitating the retention of the mating latch component 7 within the slots 3, 103).

Referring to FIG. 4, the latch components 23 can include a number of biasing elements (for example springs), such as ratchet biasing element that biases rotation of the ratchet 24 about the shaft 28 to drive the mating latch component 7 out of the slot 3 (thus moving the closure panel 6 towards the open position), pawl biasing element that biases rotation of the pawl 25 about the shaft 26 to retain the ratchet 24 in the closed position (i.e. restrict rotation of the ratchet 24 about the shaft 28 under the influence of the ratchet biasing element), cinch biasing element that can bias rotation of the cinch lever 21 towards an un-cinched position for the ratchet 24 about shaft 28 and linkage biasing element that biases return of the cinch linkage 22 towards an un-cinched position of the ratchet 24.

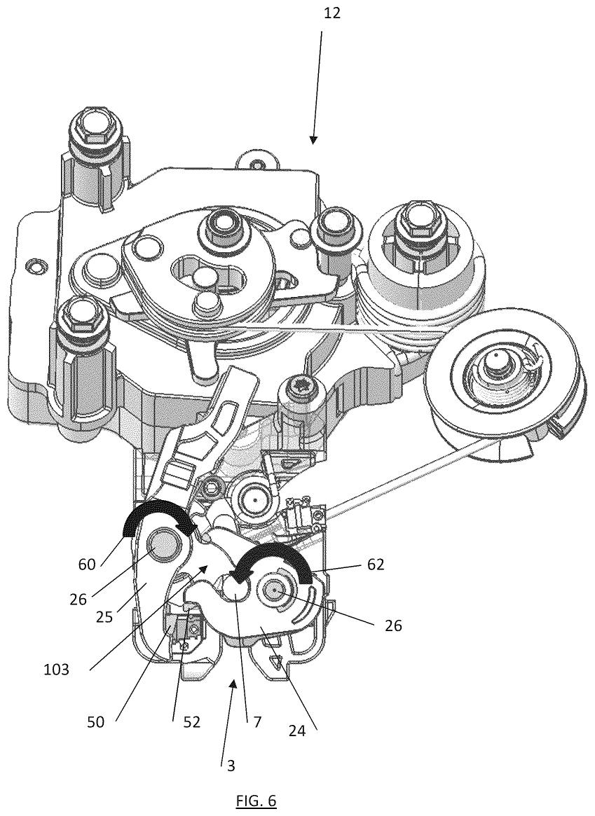

In terms of cooperation of the various latch components 23 with one another, a plurality of detents (also referred to as shoulder stops) can be employed to retain the latch components 23 in position until acted upon. For example, as can be seen in FIGS. 4,6 the ratchet 25 has a detent 50 (or shoulder stop) that mates with detent 52 (or shoulder stop) of the ratchet 24, thus retaining the ratchet 24 in the closed position. As shown in FIG. 6, rotational movement 60 of the pawl 25 about shaft 26 removes detent 50 from contact with detent 52, against the bias of pawl biasing element, thus allowing for rotational movement 62 of the ratchet 24 about the shaft 28 (e.g. under the influence of the ratchet biasing element). Rotational movement 62 results in movement of the mating latch component 7 towards the open end of the slot 3 and therefore out of the slot 103. Referring to FIG. 5, shown is detent 54 (or shoulder stop) positioned on the cinch arm lever 21 in contact with detent 56 (or shoulder stop) positioned on the ratchet 24. As such, contact between the detents 54, 56 provides for corotation of the cinch lever 21 and the ratchet 24 about the shaft 28, as further described below in relation to the cinching operation of the latch 10.

Referring again to FIG. 7, the rotary actuation system 16 can include one or more motors 90, 92 positioned in the housing 14 and coupled to the drive shaft 74. A back drive biasing element can bias the cinch lever 21 (and thereby the ratchet 24) towards the un-cinched position, while operation of the motor(s) 90,92 actuate(s) the position of the ratchet 24 towards the cinched position due to corotation of the cinch lever 21 and ratchet 24 about the shaft 28. As shown by example, the rotary actuation system 16 includes two electric motors 90 and 92. A control circuit 94 controls energization of the motors 90, 92. The control circuit 94 can include, for example, a simple switch, or more complex arrangement providing pinch resistance, express open/close, etc. as provided by a pinch detection system 100 (see FIG. 8). Motor 90 has a first rotary drive element 91 (e.g. worm gear) disposed about its output shaft 93 which engages a common rotary drive element 96 (e.g. spur gear) attached to the drive shaft 74, such that the common rotary drive element 96 drives the output shaft 74 under influence of driven rotation of one or more of the motors 90,92. It is recognized that in the event of failure of one of the motors 90,92, the other operational motor 90,92 can be used to drive the drive shaft 74 while the failed motor 90,92 remains coupled to the drive shaft 74. The output shaft 74 is provided in a driving relationship to the mechanism to be driven, e.g. the linkage system 22. The linkage system 22 can include, for example, a cable and pulley mechanism as further described below. Motor 92 has a second rotary drive element 95 (e.g. worm gear) disposed about its output shaft 97 which engages the common rotary drive element 96 (e.g. spur gear) attached to the drive shaft 74. For example, as shown in FIG. 4, the linkage system 22 can include a pulley 120 and cable 122, such that the cable 122 couples rotation of a cinch cam 110 to movement of cinch lever 21. It is recognized that the linkage system 22 could optionally include the pulley 120, as desired. For example, the cable 122 could be connected directly between the cinch cam 110 and the cinch lever 21 without an intermediate pulley or, the cable 122 could be connected indirectly between the cinch cam 110 and the cinch lever 21 via an intermediate pin or series of cable guides as is known in the art (not shown).

Referring again to FIG. 7, when both the electric motors 90 and 92 are energized via control circuit 94, drive elements 91, 95 can both independently drive the common drive element 96 and thus the drive shaft 74, thus causing the linkage system 22 to be operated and thus manipulate the attached cinch lever 21 and attached member 20. As further discussed below, manipulation of the cinch lever 21 provides for rotation of the ratchet 24 about the shaft 28 towards and into the cinched position, thus positioning the mating latch component 7 in the fully closed position in the slot 3 of the latch 10 (see FIG. 5).

Referring to FIG. 8, shown is the pinch detection system 100 as a high level block diagram showing a controller 102 (e.g. control circuit 94) which can control various actuators 104 (e.g. actuators 90, 92) based on a position of the closure panel 6 detected during cinch. Controller 102 may include circuitry for controlling the actuators, such as by controlling a current 99 supplied to the actuators. Controller 102 may include a motor controller 101 having electrical components including FETS and H-bridge for regulating the supply of the current 99 to the motor (e.g. c 104. Optional is a strut actuator 106 (e.g. lift gate actuator of the strut 8a) for automatically operating the closure panel 6 from a fully open position to the partially closed position (see FIGS. 3a, 3b) before implementation of the cinch operation (see FIG. 3c). A position sensor(s) 108 can be in many different forms, as further provided below by example. The position sensor(s) 108 can detects the absolute position of the closure panel 6, e.g. at one or more positions. The position sensor(s) 108 could be positioned on the hinge 8, in the latch 10, in the powered strut actuator 106, or a separate sensor as desired. The pinch detection system 100 can operate to know the position (between fully open and fully closed) of the closure panel 6 at all times. It is recognised that the fully closed position can also be referred to as a cinched position (i.e. the latch 10 is fully closed). The position sensor(s) 108, as well as controller 102, could be associated with, such as housed within for example, other types of actuators, such as a powered door actuator, such as described in WO2020252601A1 entitled “A power closure member actuation system”, the entire contents of which are incorporated herein by reference.

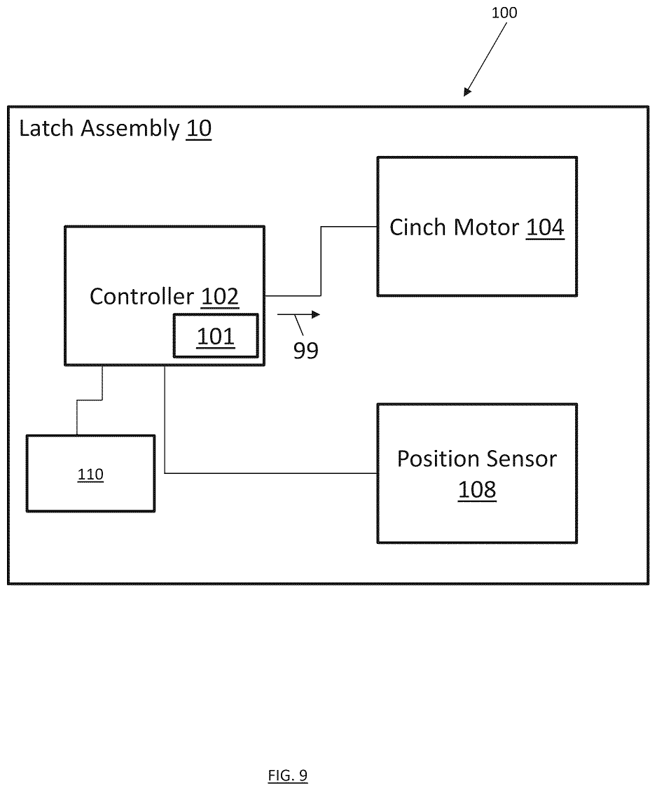

Referring to FIG. 9, shown is a further example embodiment of the pinch detection system 100, such that the physical location of the electronics is within the latch 10 (e.g. housing 14).

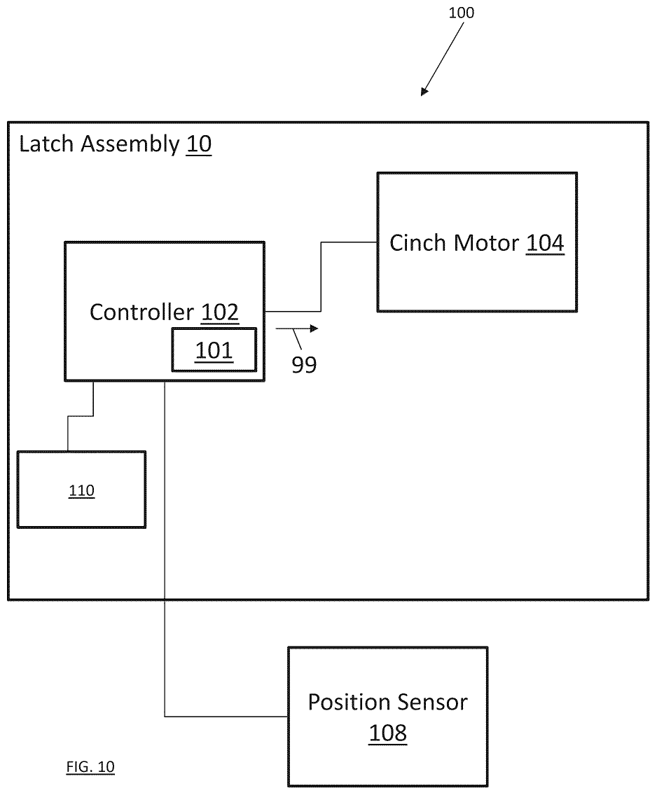

Referring to FIG. 10, shown is a further example embodiment of the pinch detection system 100, such that the position sensor 108 can detect the closure panel 6 from a sensor external the latch 10, e.g. via hinge 8, or via powered strut 8a actuator.

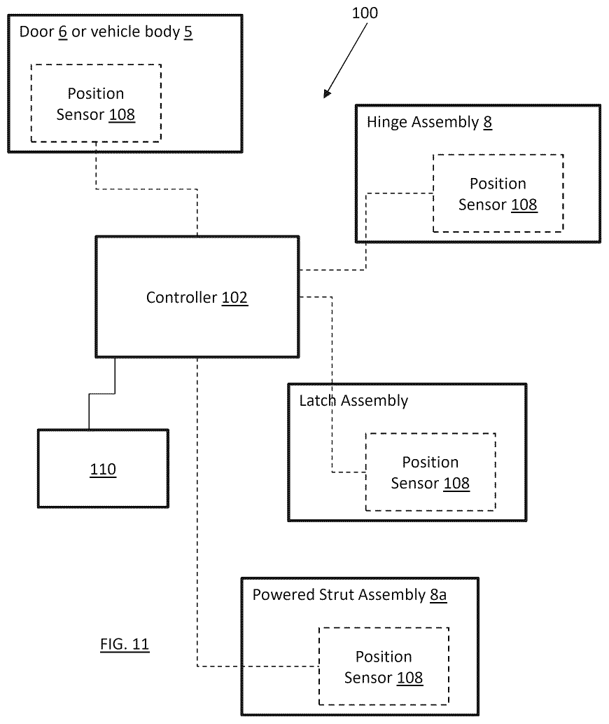

Referring to FIG. 11, shown is a further example embodiment of the pinch detection system 100, such that there can be one or more positions of possible position sensors 108.

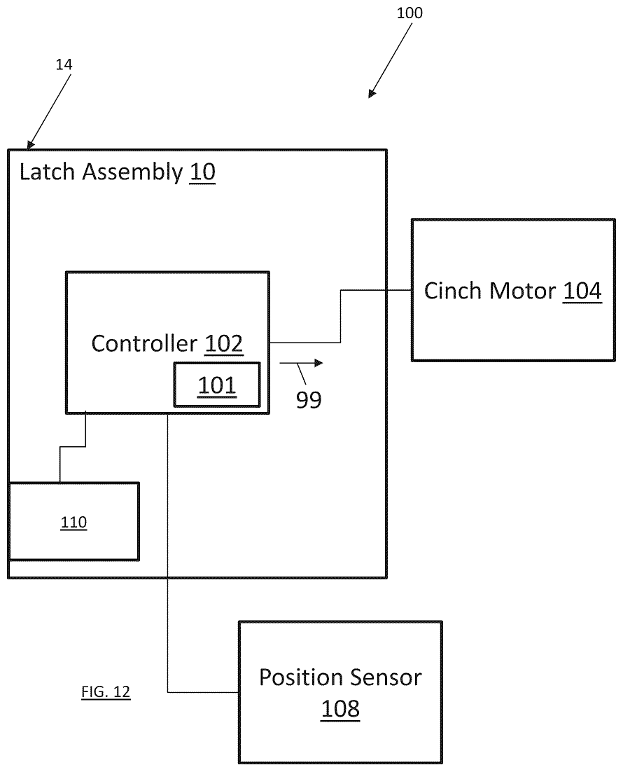

Referring to FIG. 12, shown is a further example embodiment of the pinch detection system 100, such that the cinch functionality may be configured as a cinch motor external to the housing 14 of the latch 10.

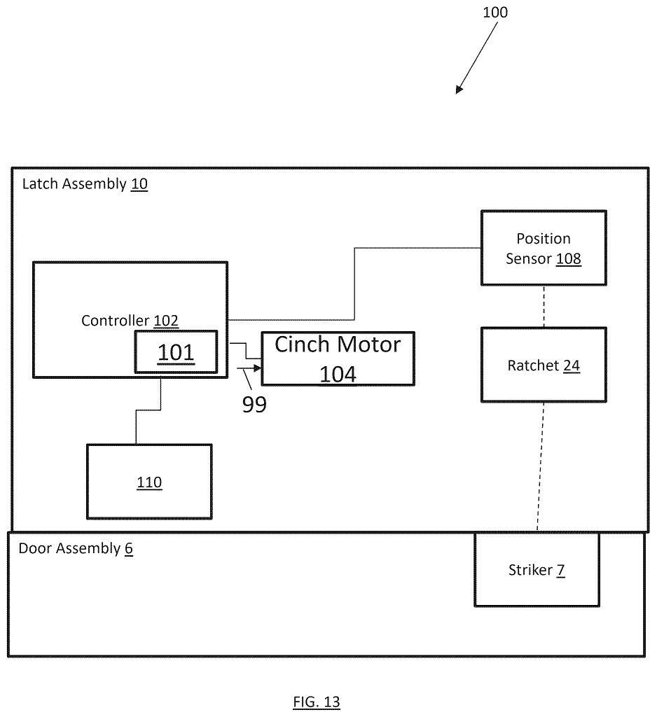

Referring to FIG. 13, shown is a further example embodiment of the pinch detection system 100, such that the sensor 108 can be associated with the ratchet 24 to detect the position of the closure panel 6 indirectly through detecting the position of the ratchet 24 about its pivot 28, recognizing that the ratchet 24 is coupled to the striker 7 during the cinching operation (as facilitated by the cinch actuator 104

Referring again to FIG. 8, the controller 102 has a computer processor 102a for processing/executing a set of stored instructions, a memory 102b for storing the instructions, and an interface 102c for sending/receiving signals (e.g. voltage measurements, current measurements, resistance measurements) to and from the other components of the pinch detection system 100 (e.g. cinch actuator(s) 104 and position sensor(s) 108).

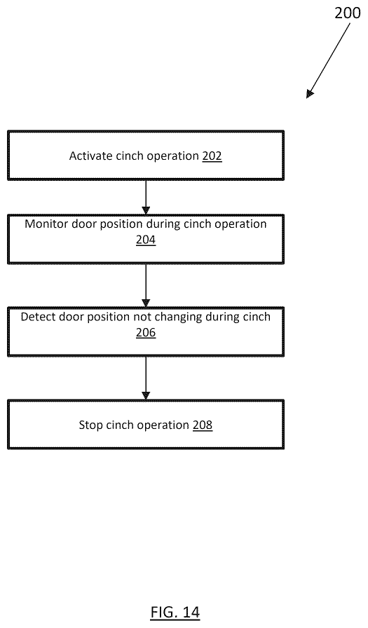

Referring to FIGS. 14, 15, 24, 25, shown are examples of controlling the cinch actuator 104 to inhibit movement of the closure panel 6 in response to detecting an improper change (e.g. the sensed position of the closure panel 6/ratchet 24 does not match the set 110 calibration data) (e.g. the sensed force/voltage/current of the cinch actuator 104 operation does not match the set 110 calibration data) in the position of the closure panel 6 during operation of the cinch actuator 104. The cinch actuator 104 may be controlled to inhibit motion of the closure panel 6 in response to detecting an improper change in the motion of the closure panel 6/ratchet 24, for example in response to an unexpected slowing in the motion of the closure panel 6/ratchet 24. A difference in the actual position or motion of the closure panel compared to an expected position or motion of the closure panel may be an example of an improper change in the position and/or motion of the closure panel 6. For example, when the motor 104 is supplied with a current 99 for moving the closure panel 6 to an expected or targeted position (6 mm), yet due to an obstacle, such as a finger, being present retarding or hindering the motion or change in position of the closure panel 6, following expiry of a period of time since supply of the current 99 the closure panel 6 is detected to not have reached the expected position (9.2 mm), the controller 102 may determine an improper change in the motion of the closure panel 6/ratchet 24 and conclude a pinch event has occurred.

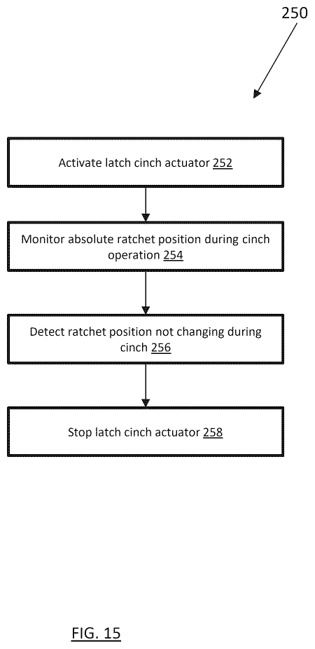

Referring to FIG. 14, shown is an example operation 200 of a pinch event detection using the pinch detection system 100 of FIG. 8. At step 202 the controller 102 activates the cinch motor 104 during closing the closure panel 6 from partially closed to fully closed, for example using the latch 10 and cinch member 20 of FIG. 2. At step 204 the controller 102 monitors the position of the closure panel 6 (either directly of indirectly) via the sensor(s) 108 during the cinch operation. At step 206, the controller 102 receives signal(s) from the position sensor(s) 108 and determines that the closure panel 6 position has not changed appropriately (e.g. the controller compares actual cinch motor 104 operation (e.g. stepper motor) and corresponding position measurements to a set 110 (see FIG. 8) of calibrated cinch motor 104 and positions (for an example calibration method 250 see FIG. 15 below)). A force profile correlated to the position of the closure panel 6 may be determined, where the force profile may be used by the controller 102 to subsequently control the cinch motor 104 to output a force based on a position of the closure panel 6 (via determination of the ratchet position, or directly by determination of the closure panel 6 position). At step 208 (stop the cinch operation), if the controller determines that the closure panel 6 position does not match the set 110 of measurements, or otherwise indicates that the cinch actuator 104 has moved while the closure panel 6 has not moved, then a pinch event is determined (e.g. determined that a foreign object 2 is impeding the closure panel movement 6 such that the movement of the closure panel 6 does not correspond with movement/operation of the cinch actuator 104).

Referring to FIG. 15, shown is an alternative operation 250 of a pinch event detection using the pinch detection system 100 of FIG. 8. At step 252, the cinch controller 102 activates the cinch motor 104 during closing the closure panel 6 from partially closed to fully closed, for example using the latch 10 and cinch member 20 of FIG. 2. At step 254 the controller 102 monitors the (absolute) position of the ratchet 24 (either directly of indirectly) via the sensor(s) 108 during the cinch operation. At step 256, the controller 102 receives signal(s) from the position sensor(s) 108 and determines that the ratchet 24 position has not changed appropriately (e.g. the controller compares actual cinch motor 104 operation (e.g. stepper motor) and corresponding position measurements to a set 110 (see FIG. 8) of calibrated cinch motor 104 and positions (for an example calibration method 250 see FIG. 15 below)). At step 258 (stop the latch cinch actuation), if the controller determines that the ratchet 24 position does not match the set 110 of measurements, or otherwise indicates that the cinch actuator 104 has moved while the ratchet 24 has not moved, then a pinch event is determined (e.g. determined that a foreign object 2 is impeding the closure panel movement 6 such that the movement of the ratchet 24 does not correspond with movement/operation of the cinch actuator 104).

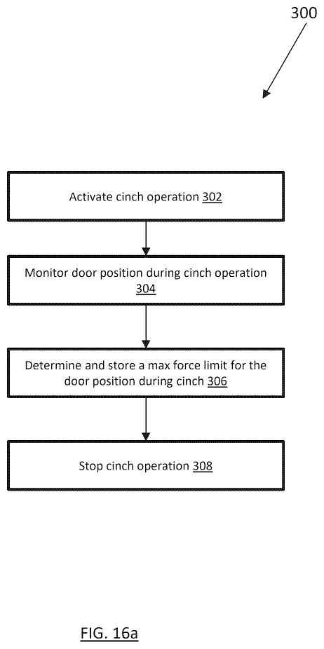

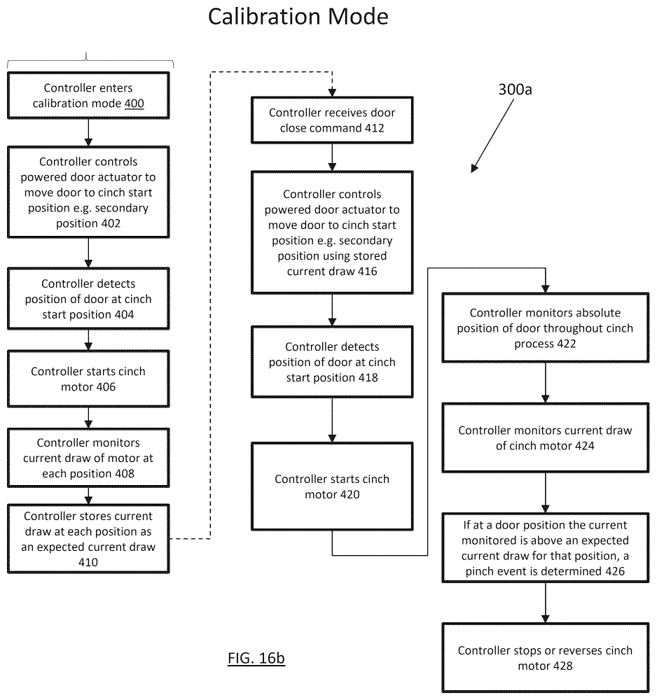

Referring to FIG. 16a, shown is an example cinch calibration operation 300. It is recognised that a maximum force limit (of the cinch actuator 104) can be the maximum output force of the cinch motor 104 (e.g. could be translated into a max voltage control of cinch motor 104) which is needed to overcome the seal 6a, which may vary over time of cinch motor 104 operation, age of the seal 6a, and/or ambient temperature and thus temperature (e.g. affecting elasticity) of the seal 6a material.

Once one determines what the cinch motor 104 output force should be at each position of the closure panel 6, such force only necessary (minimized) to overcome the seal 6a force of the closure panel 6, then the operation of the cinch motor 104 can be moderated by the controller 102 to not output more force which would contribute to damage of an object 2 (e.g. a finger), since the cinch motor 104 would not be powered to output a higher than necessary closing force.

For example, if based on calibration the system 100 knows the cinch motor 104 output force (e.g. over time/distance for closure panel 6, ratchet 24 and/or moor rotation as part of the set 110) needed to overcome the door seal 6a say at half way between secondary and primary position is 75 N, and regulations say the system 100 would maintain a pinch force below 150 N, then the system 100 would have a 75 N buffer which the cinch motor 104 can continue to be operated before a pinch detection event is determined. It is recognized that having a larger buffer can provide the system 100 more time to detect a pinch event before the cinch motor 104 force could damage the foreign object 2 (e.g. brake a finger bone etc.). As noted below by example, a non-position change can be used to detect if the pinch event is occurring, during which the current to the cinch motor 104 can increase, which would increase the force of the cinch motor 104. However, since the force can increase during this non-position change (e.g. non-position change of the ratchet 24), since the system 100 would know the minimum force at each position of the ratchet 24 (e.g. as part of the set 110) one needs to overcome the seal 6a load, and nothing more, the system 100 has a buffer for this pinch force to increase without becoming damaging during which one can determine if a pinch event has occurred.

Further, if the system 100 controls the cinch motor 104 to only be powered to overcome the max seal 6a load right before primary close (e.g. sully closed), e.g. 115 N over the entire closing range, say at half way point again your buffer is only 35 N, so the system 100 could reach a damaging force before the system 100 can reach a pinch detection event.

Referring again to FIG. 16a, at step 302 the cinch controller 102 activates the cinch motor 104 during closing the closure panel 6 from partially closed to fully closed, for example using the latch 10 and cinch member 20 of FIG. 2. At step 304 the controller 102 monitors the position of the closure panel 6/ratchet 24 (either directly of indirectly) via the sensor(s) 108 during the cinch operation. At step 306, the controller 102 receives and stores the forces (e.g. max force limits) for various positions of the ratchet 24/closure panel 6 and/or motor 104 operation while the cinch member 20 moves the closure panel 6 from the partially closed (e.g. secondary) position to the fully closed (e.g. primary) position. Step 308 stops the cinch operation. Once the force/position data has been stored in the set 110 as calibration data, then the cinch operation is completed. Referring to FIG. 16b, shown is an alternative example calibration method 300a.

For example, the Controller enters calibration mode 400, then Controller controls powered door actuator to move door to cinch start position e.g. secondary position 402, then Controller detects position of door at cinch start position 404, then Controller starts cinch motor 406, then Controller monitors current draw of motor at each position 408, then Controller stores current draw at each position as an expected current draw 410, then Controller receives door close command 412, then Controller controls powered door actuator to move door to cinch start position e.g. secondary position using stored current draw 416, then Controller detects position of door at cinch start position 418, then Controller starts cinch motor 420, then Controller monitors absolute position of door throughout cinch process 422, then Controller monitors current draw of cinch motor 424, then If at a door position the current monitored is above an expected current draw for that position, a pinch event is determined 426, then Controller stops or reverses cinch motor 428.

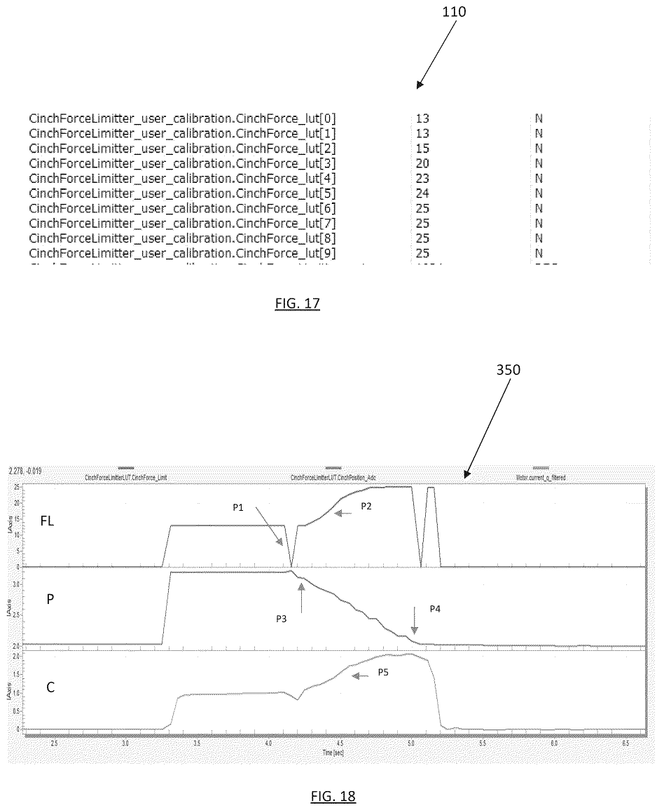

As an example of the set 110 of calibration data for cinch force, in FIG. 17 is shown 10 force zones/positions were added to the stored instructions of the controller 102. These zones show by example the amount of force (current) being provided by the latch cinch motor 102 at each zone/position (for example the ECU of the controller 102 can automatically accounts for voltage supply by lowering current accordingly). For example, in the example of forces for each zone, one can see as the ratchet 24 moves towards primary (e.g. fully closed), the forces increase because the seal 6a load increases (representing an increasing amount of compression of the seal 6a). For example, the positions of where these zones take effect can be determined by splitting the voltage range between secondary and primary positions into 10 equal parts.

Referring to FIG. 18, shown is an example force/position/current over time graph 350 for a normal close cycle, such that the current directly follows the force limit curve of the amount of force being provided by the cinch motor 104 during operation over time. For example for force limit FL, position P and current C. At point P1 Force is set to zero here because position is greater than expected (can be ignored), At point P2 Force limit increases based on position. At point P3 Start of ratchet rotation by cinch motor. At point P4 Reached fully cinched position. At point P5 Current follows force limit.

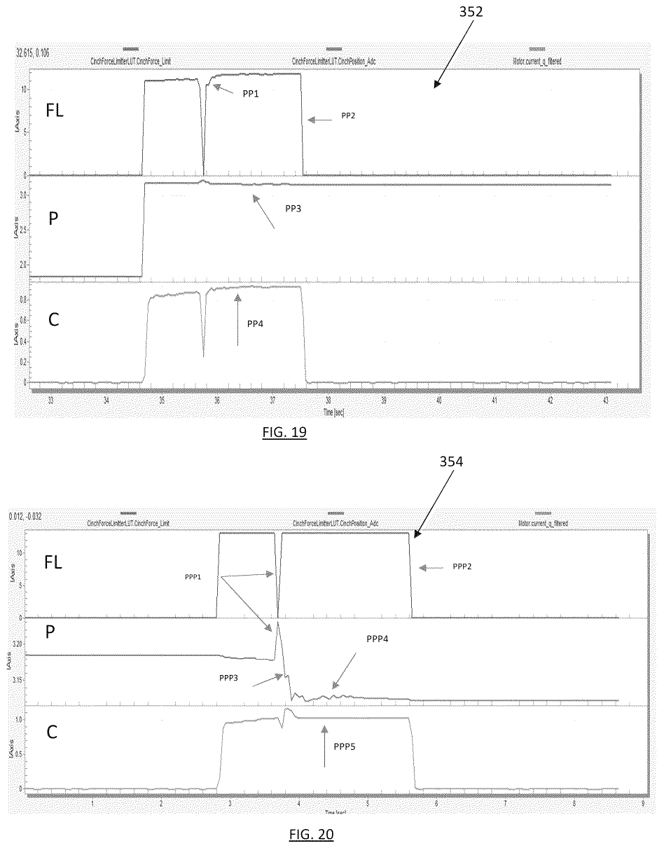

Referring to FIG. 19, shown is an example force/position/current over time graph 352 in which a pinch event occurs at 9.5 mm, e.g. no change in ratchet 24 position detected by the controller 102. For example, pinch force 48.3N (e.g. cinch motor 104 output) set to 41.7N to overcome seal 6a load at 9.5 mm such that total cinch motor 104 force contributing to pinch on a finger 2 is 48.3N if max force target is set to 100N. At point PP1 Force is set to zero here because position is greater than expected (can be ignored). At point PP2 Obstacle Detected. At point PP3 Position not changing because there is an obstacle. At point PP4 Current stays constant.

Referring to FIG. 20, shown is an example force/position/current over time graph 354 in which a pinch event occurs at 8.2 mm e.g. no change in ratchet 24 position detected. Pinch Force 50.1N (e.g. cinch motor 104 output) set to 49.1N to overcome seal 6a load at 8.2 mm such that total cinch motor 104 force contributing to pinch on a finger 2 is 50.1N if max force target is set to 100N. At point PPP1 Force is set to zero here because position is greater than expected (can be ignored). At point PPP2 Obstacle Detected. At point PPP3 Ratchet Rotating. At point PPP4 Position not changing because there is an obstacle. At point PPP5 Current stays constant.

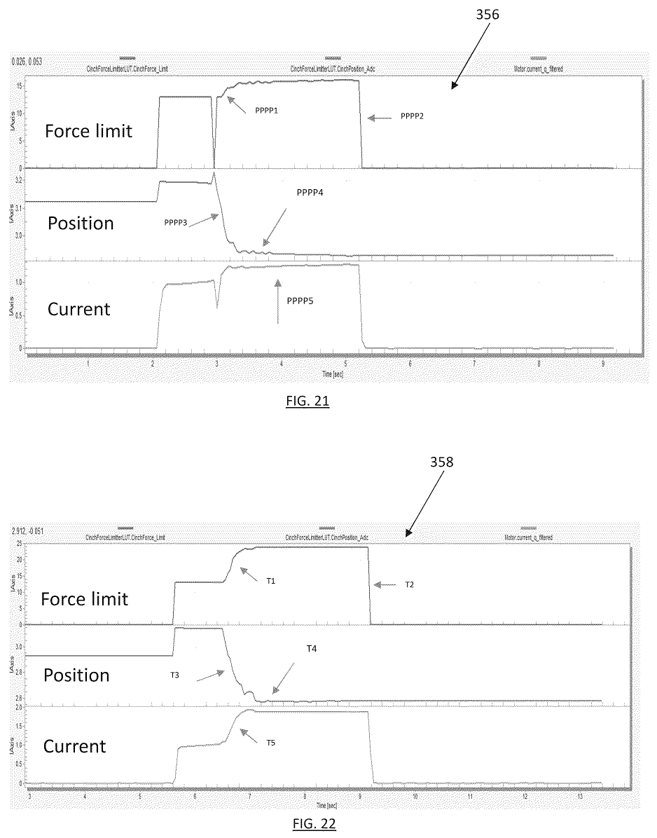

Referring to FIG. 21, shown is an example force/position/current over time graph 356 in which a pinch event occurs at 6.6 mm. Pinch Force 38.1N (e.g. cinch motor 104 output) set to 61.9N to overcome seal 6a load at 6.6 mm such that total cinch motor 104 force contributing to pinch on a finger 2 is 38.1N if max force target is set to 100N. At point PPPP1 Force limit increases with seal load. At point PPPP2 Obstacle Detected. At point PPPP3 Ratchet Rotating. At point PPPP4 Position not changing because there is an obstacle. At PPPP5 Current stays constant.

Referring to FIG. 22, shown is an example force/position/current over time graph 358 in which a pinch event occurs at 5.2 mm. Pinch Force 69.8N (e.g. cinch motor 104 output) set to 31.2N to overcome seal 6a load at 5.2 mm such that total cinch motor 104 force contributing to pinch on a finger 2 is 69.8N if max force target is set to 100N. At point T1 Force limit increases with seal load. At point T2 Obstacle Detected. At point T3 Ratchet Rotating. At point T4 Position not changing because there is an obstacle. At T5 Current stays constant.

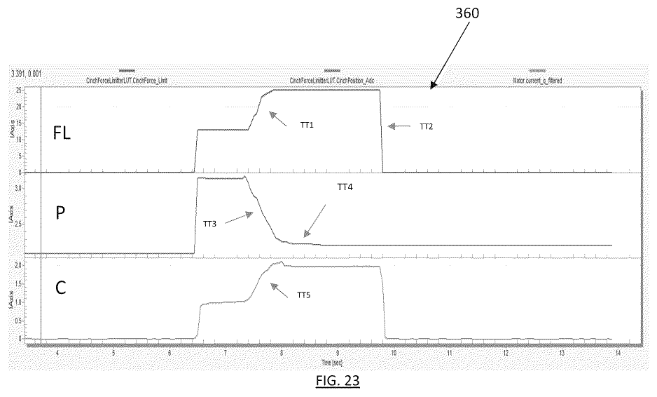

Referring to FIG. 23, shown is an example force/position/current over time graph 360 in which a pinch event occurs 4 mm. Pinch Force 37.7N (e.g. cinch motor 104 output) set to 62.3N to overcome seal 6a load at 4 mm such that total cinch motor 104 force contributing to pinch on a finger 2 is 37.7N if max force target is set to 100N. At point TT1 Force limit increases with seal load. At point TT2 Obstacle Detected. At point TT3 Ratchet Rotating. At point TT4 Position not changing because there is an obstacle. At TT5 Current stays constant.

In view of the above presented examples, it is recognized that operation of the pinch detection system 100 provides a maximum of 70N pinch force over all the gap lengths testing. This can be considered well below the example required threshold of 100N. Therefore the actuator 104 may be controlled such that the force applied to an obstacle, such as a finger, does not exceed a predetermined force as the closure panel is being moved from a first position (such as for example a cinch start position, or door partially opened position) to a second position (such as a cinch stop or door closed position for example) against a vehicle component having a variable resistance acting against the closing of the closure panel, due to for example the door seal, as well as the resistance of the obstacle (e.g. the finger). Other types of variable system resistance may be provided, for example in the configuration of the closure panel 6 as a front trunk panel, or Frunk closure panel, whereby the variable resistance is provided by a pop-up spring, or spring-loaded lift mechanism. An example of a Frunk closure panel system is shown in US20210370864A1 entitled “Active Pedestrian Protection System Using Non-Contact Forward Sensing and Hood Latch Assembly with Spring Loaded Actuator”, the entire contents of which are incorporated herein by reference. The actuator 104 may be controlled such that the force applied to an obstacle increases based on a correlation with a position of the closure panel 6. Still, the actuator 104 may be controlled in correlation to the position of the closure panel 6 such that the force applied to the obstacle remains below a total predetermined force (Newtons) as the closure panel 6 is being moved from a first position (such as for example a cinch start position, or door partially opened position) to a second position (such as a cinched position, or door closed position). Therefore, the pinch detection system 100 may be configured to move the closure panel 6 against a system resistance (a resistance provided by a door seal, spring lift mechanism, as examples) by compensating for the known resistance acting against the closure panel 6 motion between positions, and without causing the closure panel 6 to apply a force above maximum predetermined force. A force range between the force outputted by the actuator 104 in order to overcome the system resistance and the maximum predetermined force allows an obstacle, such as a finger, to be subjected to an increase in the force outputted by the actuator 104 below the maximum predetermined force during a pinch event being detected and the actuator 104 being controlled in response to a pinch event being detected to inhibit further motion of the closure panel 6.

A linear potentiometer (e.g. sensor 108) can be used to determine closure panel 6 position. However, any sensor 108 that can provide and accurate and precise position of the closure panel 6 (e.g. liftgate) would be suitable. Further, the number of items in the table of FIG. 17 does not have to be limited to 10. This can be adjusted according to the precision required.

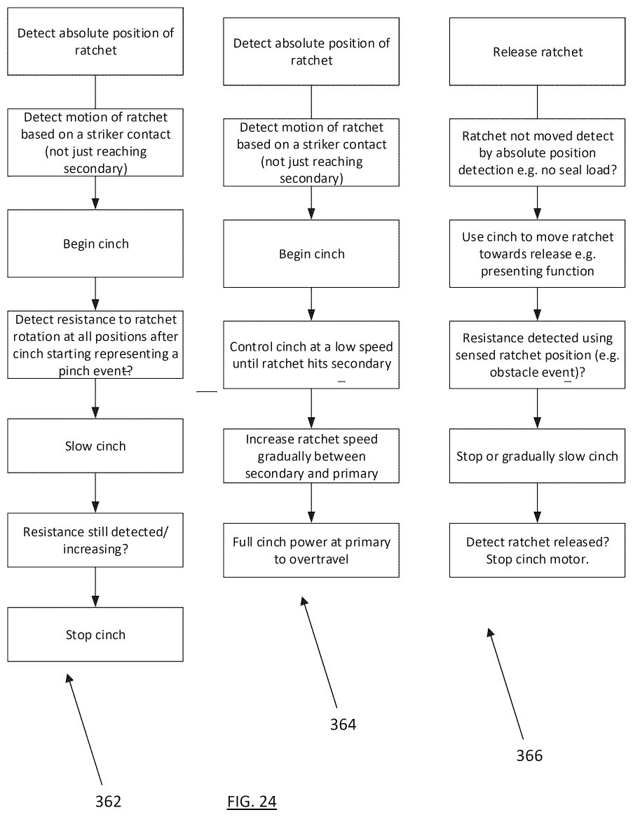

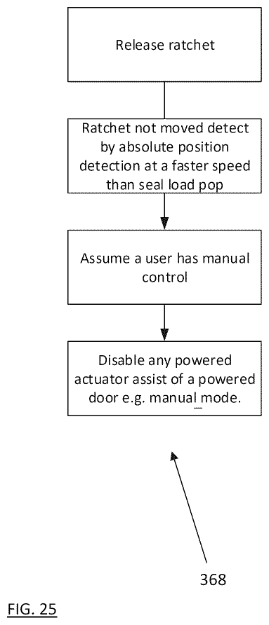

Referring to FIGS. 24, 25, shown are further examples of the operation of the pinch detection system 100 (see FIG. 8): embodiment 362 as detect absolute position of ratchet, then detect motion of ratchet based on a striker contact (not just reaching secondary), then begin cinch, then detect resistance to ratchet rotation at all positions after cinch starting representing a pinch event, then slow cinch, then resistance will detected/increasing?, then stop cinch; embodiment 364 as detect absolute position of ratchet, then detect motion of ratchet based on a striker contact (not just reaching secondary), then begin cinch, then control cinch as a low speed until ratchet hits secondary, then increase ratchet speed gradually between secondary and primary, then full cinch power at primary to overtravel; embodiment 366 as release ratchet, then ratchet not moved detect by absolute position detection e.g. no seal load?, then use cinch to move ratchet towards release e.g. presenting function, then stop or gradually slow cinch, then detect ratchet released? Stop cinch motor; embodiment 368 as release ratchet, then ratchet not moved detect by absolute position detection at a faster speed that seal load pop, then assume a user has manual control, then disable any powered actuator assist of a powered door e.g. manual mode.

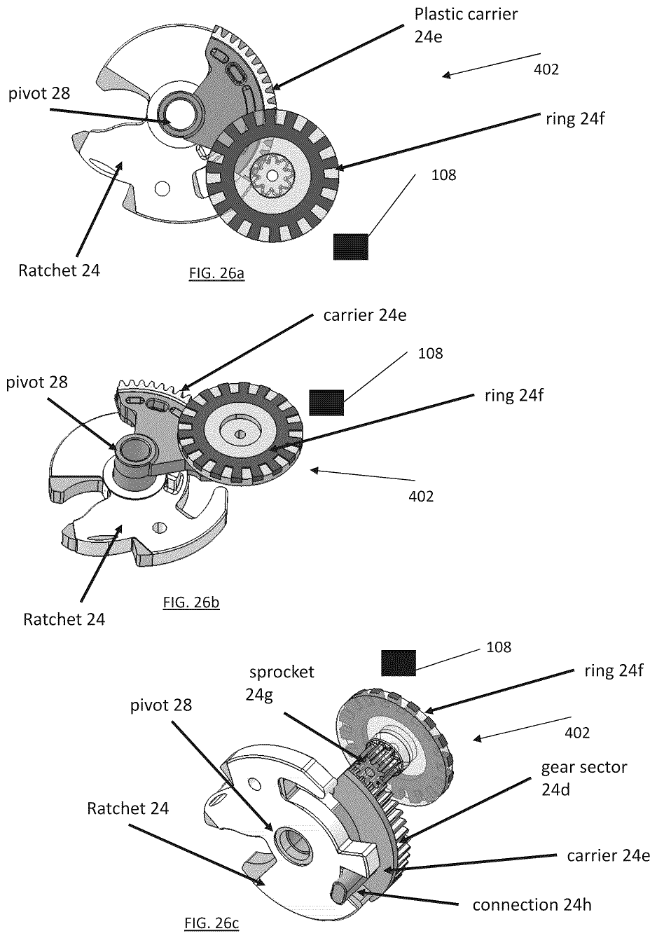

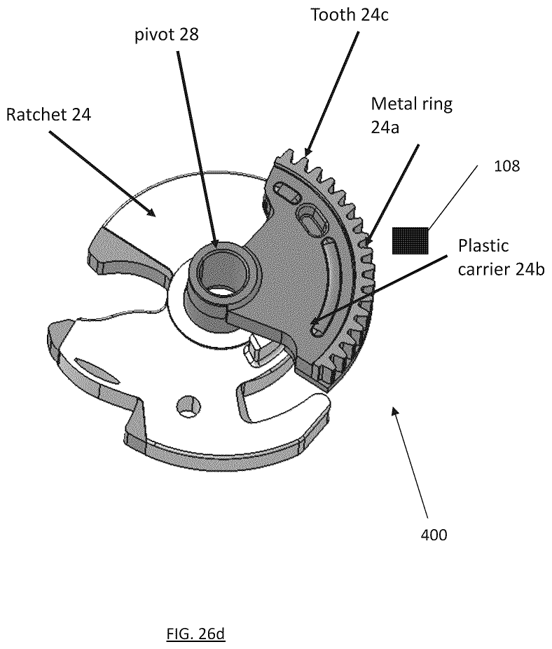

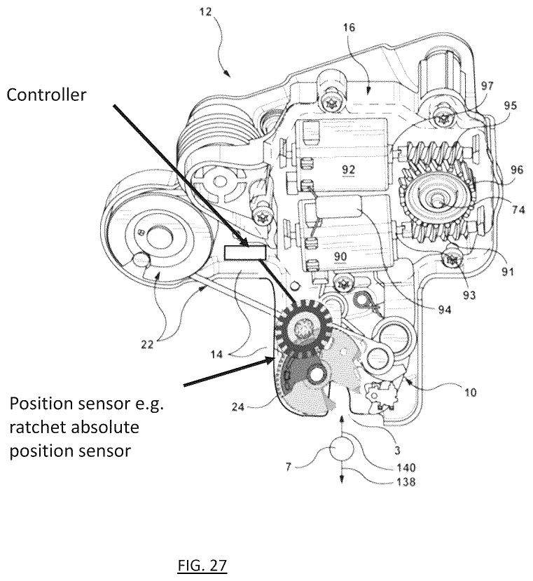

Referring to FIG. 26d, shown is an example embodiment sensor arrangement 400 mounted on a ratchet 24 used to indicate/measure the degree of closure of the closure panel 6. A metal ring 24a is attached to the ratchet 24 by a carrier 24b (e.g. plastic). Therefore, as the ratchet rotates about the pivot 28, the sensor 108 can be positioned to detect movement of the individual teeth (e.g. protrusions 24c) of the metal ring 24a. For example, the ratchet 24 position can be difficult to sense more than 90deg, as typically the exposed portion of the ratchet 24 is not covered by the latch fish mouth (e.g. slot 3—see FIG. 6). For example, where typical rotation of the ratchet 24 from fully open to fully closed position is around 70deg, the ratchet rotation from secondary portion to primary position is usually between 25-35deg and the striker 7 travel during the cinch function is approximately 6-8 mm. This is the range (25-35deg) that the anti-pinch operation of the controller 102 (e.g. configured to detect the presence of the foreign object 2 as given by example above) could cover to detect potential pinching. Further, load at secondary position is normally 50-100N and it can increase quickly to 300-500N in the 6-8 mm travel (average 80N/mm) range. Further, it is recognize that magnetic rings can be expensive, however it can be understood that there are sensors 108 that can use perturbation of the magnetic field generated by metal parts to detect transition for example from one tooth 24c of the metal ring 24a to other tooth 24c of the metal ring 24a.

Referring to FIG. 26a, b, c, resolution of the separation between the teeth 24c can be increased using the embodiment sensor arrangement 402 shown. A carrier 24e is coupled to the ratchet 24 by a connection 24h (e.g. pin and slot arrangement) so that the carrier 24e rotates about the pivot 28. The carrier 24e has a series of teeth 24c on a sector gear 24d. It is recognized that the carrier 24e and the sector gear 24d can be made of a nonmagnetic (e.g. plastic) material. Further, a ring 24f is mounted on the scot gear 24e by a gear/sprocket 24g, such that rotation of the gear 24d about the pivot 28 also causes rotation of the ring 24f. For example, the metal ring 24f is preferred, however in alternative it could be a magnetic ring 24f. Gear/sprocket 24g may be configured as a geartrain coupling the ratchet 24 to the sensor 108 providing speed multiplication of the rotation of the ratchet 24 to the ring 24f, as a result of which small motions of the ratchet 24 are translated into larger motions of the ring 24f which may provide increased resolution of ratchet position changes for the sensor 108. A lower resolution sensor 108 may also therefore be provided. However, a sensor, 108 such as a higher resolution position sensor may be coupled without speed multiplication to the ratchet 24.

One advantage with the embodiment of FIG. 26a, b, c is an advantage where one can use 360deg of plastic carrier 24e/metal ring 24f rotation. Further, gear 24d rotation of the sector with the plastic carrier 24e can be 1 to 4 means for 1 deg of the magnet ring 24f rotation, when one has 0.25deg only of ratchet 24 rotation about the pivot 28. This embodiment can be used to increase the accuracy of the ratchet 24 rotation detection and facilitate the recognition of the ratchet 24 position and load increase in case of pinch event occurring, as monitored/detected by the pinch detection system 100. Referring to FIG. 27, shown is the sensor arrangement 402 mounted to the ratchet 24 as part of the latch 10, wherein the striker 7 can move 138, 140 into and out of the slot 3, using the position sensor as an absolute position sensor by example.

The various illustrative logical blocks, modules, and circuits described in connection with the embodiments disclosed herein (e.g. the controller 102, the control circuit 94, etc.) can be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program (e.g. including the set 110 of calibration data as well as any of the steps shown in FIGS. 14, 15, 16a, 16b, 24, 25 stored in a computer memory) include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (i.e. computer memory) for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media (e.g. computer memory) includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

1-20. (canceled)

21. A vehicle latch comprising:
a ratchet pivotable about a ratchet pivot between an open position and a closed position for retaining a striker;
a sensor for detecting movement of a component, the movement of the component imparted by the pivoting of the ratchet; and
a geartrain coupling the component to the ratchet;
wherein the sensor is configured to output a signal indicative of the position of the ratchet by detecting the position of the component.

22. The vehicle latch of claim 21, wherein the component comprises a ring coupled to the ratchet for rotation with the ratchet about the ratchet pivot, the ring including a plurality of teeth; and wherein the sensor is positioned to detect movement of the teeth of the ring and to generate a signal indicative of a position of the ratchet.

23. The vehicle latch of claim 21, wherein the sensor is configured to detect perturbations of a magnetic field produced by the component.

24. The vehicle latch of claim 21, wherein the sensor is connected to a controller configured to use the signal to monitor motion of the ratchet during the cinch operation.

25. The vehicle latch of claim 21, wherein geartrain train comprises a first gear coupled to the ratchet, and a second gear meshed with the first gear, the second gear coupled to the component.

26. The vehicle latch of claim 21, wherein the sensor is connected to a controller configured to use an absolute position signal outputted by the sensor to monitor motion of the ratchet during the cinch operation.

27. A vehicle latch assembly for cinching a closure panel from a partially closed position to a fully closed position, comprising:
a latch including a ratchet movable between a secondary capture position and a primary capture position for retaining a striker;
an actuator configured to drive the ratchet from the secondary capture position toward the primary capture position during a cinch operation;
a position sensor configured to output a position signal indicative of a movement of the ratchet during the cinch operation; and
a controller coupled to the actuator and to the position sensor, the controller configured to perform a calibration during the cinch operation in which the controller receives the position signal to determine calibration data to be used by the controller during a subsequent cinch operation.

28. The latch assembly of claim 27, wherein the calibration data comprises a cinch force.

29. The latch assembly of claim 27, wherein the calibration data defines a target output profile comprising a variable actuator output as a function of position between the secondary capture position and the primary capture position.

30. The latch assembly of claim 27, wherein the calibration data is configured to compensate for a closing resistance that varies as the closure panel approaches the fully closed position due to variations of a door seal.

31. The latch assembly of claim 27, wherein the controller stores the calibration data as a plurality of discrete zones across a cinch travel range.

32. The latch assembly of claim 31, wherein each zone including a respective expected value or limit value of the cinching parameter.

33. The latch assembly of claim 27, wherein the position sensor is configured to provide an absolute position of the ratchet.

34. The latch assembly of claim 33, further comprising a geartrain coupling the ratchet to a sensor target such that rotation of the ratchet is speed-multiplied for sensing by the position sensor.

35. The latch assembly of claim 27, wherein the controller is configured to update the stored calibration data to compensate for variations over time in the cinch operation.

36. The latch assembly of claim 35, wherein the controller is configured to update the stored calibration data to compensate for variations in ambient temperature, supply voltage, closure panel type, or seal aging.

37. A method of operating a cinching vehicle latch, comprising:
controlling a cinch actuator to move a ratchet from a secondary capture position toward a primary capture position while receiving a position signal indicative of closure progress;
during a calibration cinch cycle, measuring at least one cinching parameter of the cinch actuator as a function of the position signal;
storing calibration data correlating the cinching parameter to position; and
during a subsequent cinch cycle following the calibration cinch cycle, controlling the cinch actuator according to the stored calibration data.

38. The method of claim 37, wherein storing the calibration data comprises storing a force profile or a current profile indexed by position.

39. The method of claim 37, further comprising updating the calibration data.

40. The method of claim 37, where receiving a position signal indicative of closure progress comprises receiving an absolute position signal indicated of the position of the ratchet.
